(19) United States
(12) Patent Application Publication
(10) Pub. No.: US 2024/0314639 A1
(43) Pub. Date: Sep. 19, 2024

(54) WIRELESS COMMUNICATION SYSTEM, CONTROL METHOD FOR WIRELESS COMMUNICATION SYSTEM, WIRELESS MASTER STATION DEVICE

(71) Applicant: NIPPON TELEGRAPH AND TELEPHONE CORPORATION, Tokyo (JP)

(72) Inventors: Hitoshi HASEGAWA, Musashino-shi, Tokyo (JP); Toshifumi MIYAGI, Musashino-shi, Tokyo (JP); Hayato FUKUZONO, Musashino-shi, Tokyo (JP)

(73) Assignee: NIPPON TELEGRAPH AND TELEPHONE CORPORATION, Tokyo (JP)

(21) Appl. No.: 18/576,767

(22) PCT Filed: Jul. 27, 2021
(86) PCT No.: PCT/JP2021/027794

§ 371 Date: Jan. 5, 2024

(51) Int. Cl. H04W 28/18; H04W 28/02

(52) U.S. Cl. CPC H04W 28/18; H04W 28/0236; H04W 28/0273

(57) ABSTRACT

A wireless communication system according to the present disclosure accommodates a plurality of different services. The wireless communication system includes a wireless master station device and a wireless slave station device. The wireless master station device and the wireless slave station device perform wireless communication using an adaptive modulation technique via a plurality of ports. A priority is set to each of the plurality of ports according to a type of service accommodated by the port. The wireless communication system is configured so as to block the ports in order of low priority when a radio band decreases due to deterioration of a wireless environment, and to open the blocked ports in order of high priority when the radio band recovers due to improvement of the wireless environment.

### TECHNICAL FIELD

The present invention relates to a wireless communication system, a method of controlling the wireless communication system, and a wireless master station device.

### BACKGROUND ART

For example, Patent Literature 1 discloses a communication system that performs wireless communication. As the communication system that performs wireless communication, there is a conventional wireless communication system that employs an adaptive modulation technique that changes a modulation scheme according to the quality of a wireless section.

### CITATION LIST

### Patent Literature

Patent Literature 1: JP 2019-208188 A

### SUMMARY OF INVENTION

### Technical Problem

In a wireless communication system employing an adaptive modulation technique, the number of available lines decreases as a modulation scheme is changed due to quality degradation of a wireless section. In the conventional wireless communication system adopting the adaptive modulation technique, as the number of available lines decreases, a specific port becomes unusable regardless of a type of service. For example, a dedicated line for which a Service Level Agreement (SLA) is set and a public telephone which is a universal service are lines with high importance, but conventionally, there has been a problem that such lines with high importance cannot be used.

The present invention has been made in view of the above-described problems. An object of the present invention is to provide a wireless communication system, a method of controlling the wireless communication system, and a wireless master station device capable of securing communication quality of a highly important line.

### Solution to Problem

A wireless communication system according to an aspect of the present invention accommodates a plurality of different services. The wireless communication system includes a wireless master station device and a wireless slave station device. The wireless master station device and the wireless slave station device perform wireless communication using an adaptive modulation technique via a plurality of ports. A priority is set to each of the plurality of ports according to a type of service accommodated by the port. The wireless communication system is configured so as to block the ports in order of low priority when a radio band decreases due to deterioration of a wireless environment, and to open the blocked ports in order of high priority when the radio band recovers due to improvement of the wireless environment.

In addition, in a method of controlling the wireless communication system according to an aspect of the present invention, the wireless communication system includes the wireless master station device and the wireless slave station device that perform wireless communication using the adaptive modulation technique via a plurality of ports and accommodates a plurality of services. The method of controlling the wireless communication system includes: a step of setting the priority to each of the plurality of ports according to the type of service accommodated by the port; a step of blocking the ports in order of low priority when the radio band decreases due to deterioration of the wireless environment; and a step of opening the blocked ports in order of high priority when the radio band recovers due to improvement of the wireless environment.

In addition, the wireless master station device according to an aspect of the present invention constitutes the wireless communication system that accommodates a plurality of different services by performing wireless communication using the adaptive modulation technique with the wireless slave station device via a plurality of ports. The wireless master station device includes a wireless unit that performs wireless communication with the wireless slave station device, a control unit that controls a modulation scheme of communication by the wireless unit according to a change in the wireless environment, and an interface unit that blocks and opens a plurality of ports. A priority is set to each of the plurality of ports according to a type of service accommodated by the port. The control unit controls the interface unit such that when the radio band decreases due to deterioration of the wireless environment, the ports are blocked in order of low priority, and when the radio band recovers due to improvement of the wireless environment, the ports are opened in order of high priority.

### Advantageous Effects of Invention

According to the present invention, communication quality of a line with high importance can be secured.

### BRIEF DESCRIPTION OF DRAWINGS

FIG. 1 is a conceptual diagram illustrating an operation of a wireless communication system according to a first embodiment.

FIG. 2 is a functional block diagram illustrating main functions of the wireless communication system according to the first embodiment.

FIG. 3 is a diagram illustrating an operation flow of each functional unit of the wireless communication system according to the first embodiment.

FIG. 4 is a diagram illustrating a hardware configuration example for realizing each function of the wireless communication system.

### DESCRIPTION OF EMBODIMENTS

Hereinafter, an embodiment will be described with reference to the accompanying drawings. In the present disclosure, redundant description will be simplified or omitted as appropriate. Note that the present disclosure is not limited to the embodiments described below. The present disclosure may include various modifications and combinations of configurations disclosed by the following embodiment without departing from the spirit of the present disclosure.

### First Embodiment

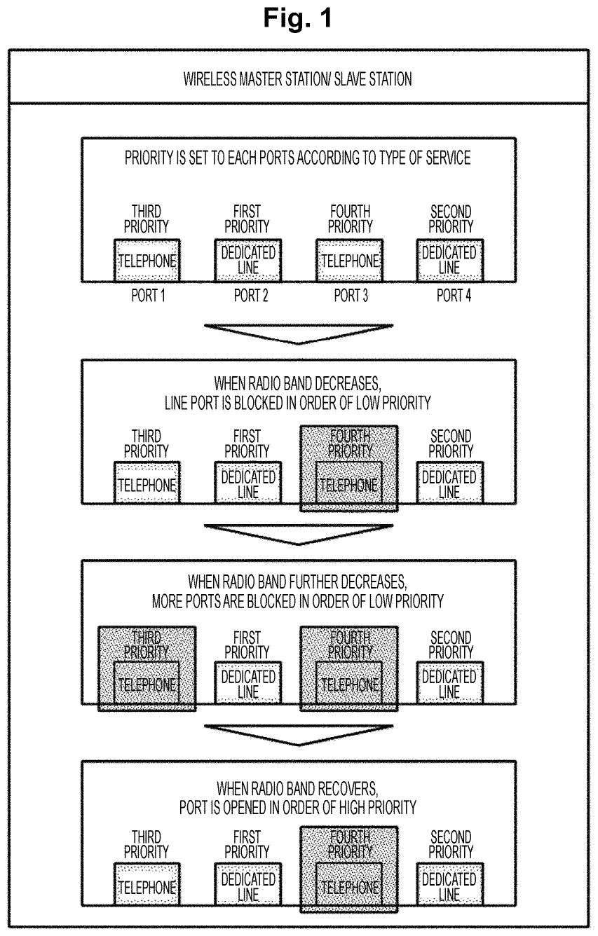

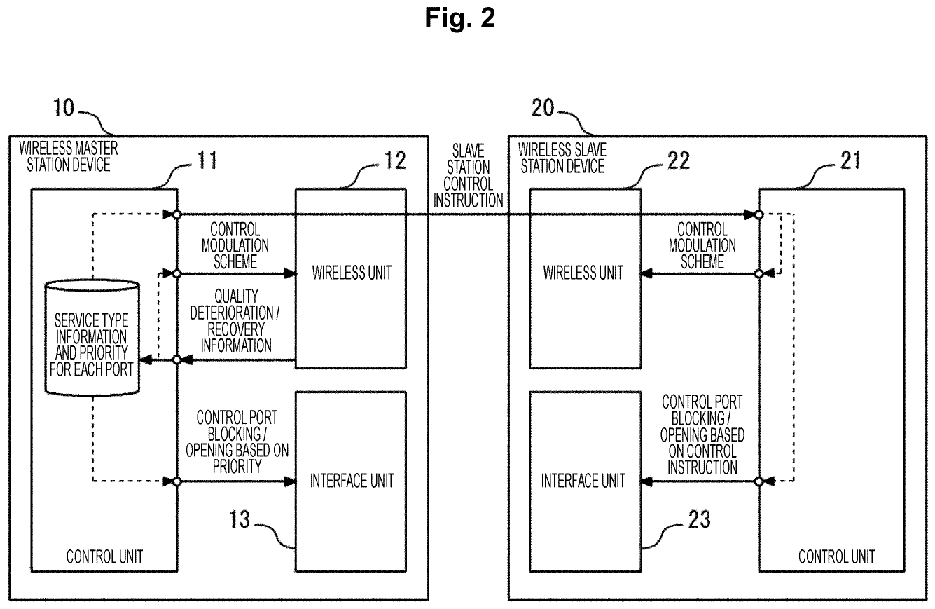

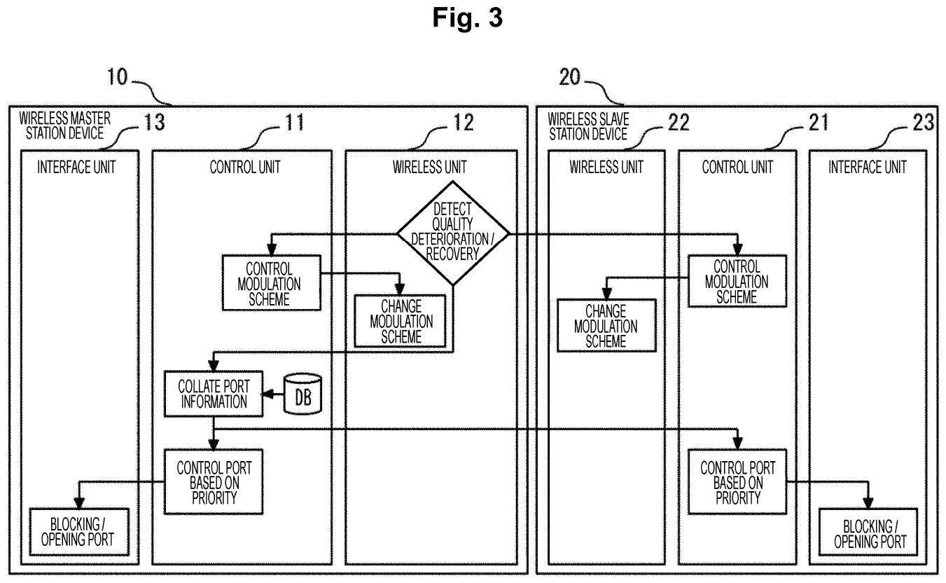

FIG. 1 is a conceptual diagram illustrating an operation of a wireless communication system according to the first embodiment. FIG. 2 is a functional block diagram illustrating main functions of the wireless communication system according to the first embodiment. FIG. 3 is a diagram illustrating an operation flow of each functional unit of the wireless communication system according to the first embodiment.

The wireless communication system according to the present embodiment accommodates a plurality of different services. The wireless communication system accommodates mixed services such as a fixed phone, a dedicated line, and an IP line.

The wireless communication system according to the present embodiment includes a wireless master station device 10 and a wireless slave station device 20. The wireless master station device 10 and the wireless slave station device 20 perform wireless communication using an adaptive modulation technique via a plurality of ports. Note that the wireless communication system according to the present disclosure is not limited to a fixed wireless communication system that performs one-to-one communication, and may be, for example, a fixed/mobile wireless communication system that performs one-to-many communication (a system in which a plurality of slave stations are connected to one master station).

In the present embodiment, a priority is set to each of the plurality of ports according to a type of service accommodated by the port. For example, the priority is set in the order of a public telephone, a dedicated line, and a fixed telephone.

As illustrated in FIG. 1, the wireless communication system according to the present embodiment is configured such that the ports are blocked in order of low priority when the radio band decreases due to deterioration of the wireless environment, and the ports are opened in order of high priority when the radio band recovers due to improvement of the wireless environment. According to the wireless communication system configured as described above, it is possible to secure the communication quality of a line with high importance. Note that each function of the wireless communication system can also be implemented as a method of controlling the wireless communication system.

As an example, the wireless master station device 10 includes a control unit 11, a wireless unit 12, and an interface unit 13. As an example, the wireless slave station device 20 includes a control unit 21, a wireless unit 22, and an interface unit 23.

The control unit 11 functions as a control means that controls movement of the wireless master station device 10 and the wireless slave station device 20. The control unit 21 functions as a control means that controls movement of the wireless slave station device 20. The control unit 21 controls an operation of the wireless slave station device 20 on the basis of a control instruction from the control unit 11. In the present embodiment, the wireless slave station device 20 operates on the basis of a control instruction from the wireless master station device 10.

The wireless unit 12 and the wireless unit 22 are for performing a wireless communication technology. Wireless communication is performed via the wireless unit 12 and the wireless unit 22.

When the environment of the wireless communication by the wireless unit 12 and the wireless unit 22 changes, a modulation scheme of the communication by each wireless unit is controlled according to the change. The control of the modulation scheme of the wireless unit 12 is performed by the control unit 11. The control of the modulation scheme of the wireless unit 22 is performed by the control unit 21. The control unit 11 and the control unit 21 perform control according to a detection result of deterioration or recovery of communication quality. Each wireless unit changes the modulation scheme based on a control instruction from each control unit. For example, information on deterioration or recovery of the quality is transmitted from the wireless unit 12 to the control unit 11.

The control unit 11 acquires the information from a database having service classification information and priority information of each port. The control unit 11 collates each port on the basis of acquired information, and performs port control based on priority of each port. The control unit 11 transmits a control instruction for each port to the interface unit 13 and the control unit 21. The control unit 21 transmits a control instruction for each port to the interface unit 23.

The interface unit 13 and the interface unit 23 are functional units that block and open a plurality of ports. The interface unit 13 blocks and opens each port according to a priority on the basis of a control instruction from the control unit 11. The interface unit 23 blocks and opens each port according to a priority on the basis of a control instruction from the control unit 21.

Some or all of the functions of the wireless communication system according to the above embodiment may be implemented by using hardware such as an Application Specific Integrated Circuit (ASIC), a Programmable Logic Device (PLD), or a Field Programmable Gate Array (FPGA). Each function of the wireless communication system may be implemented by a combination of dedicated hardware and software. In addition, some or all of the functions of the wireless communication system may be formed as a program executed by a processor such as a CPU. The program may be recorded in a computer-readable storage medium.

For example, each function of the wireless communication system can be realized by using a computer and a program, and the program can be recorded in a storage medium or provided through a network.

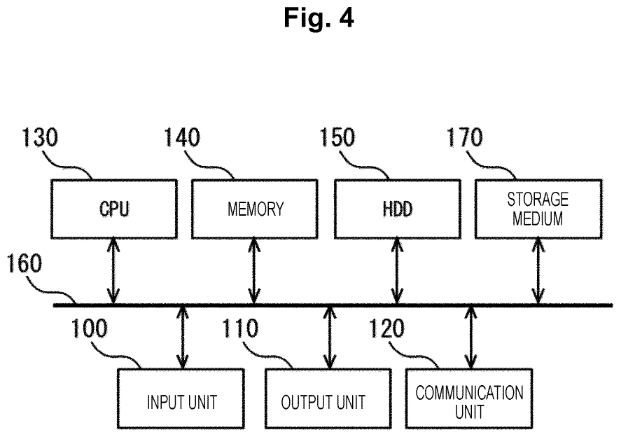

FIG. 4 is a diagram illustrating a hardware configuration example for implementing each function of the wireless communication system. As illustrated in FIG. 4, each function of the wireless communication system is implemented by, for example, an input unit 100, an output unit 110, a communication unit 120, a CPU 130, a memory 140, an HDD 150, and the like. The input unit 100, the output unit 110, the communication unit 120, the CPU 130, the memory 140, and the HDD 150 are connected via a bus 160 and have a function as a computer. In addition, the computer including the input unit 100, the output unit 110, the communication unit 120, the CPU 130, the memory 140, the HDD 150, and the like can input and output data to and from a computer-readable storage medium 170.

The input unit 100 is, for example, a keyboard, a mouse, or the like. The output unit 110 is, for example, a display device such as a display. The communication unit 120 is, for example, a wireless network interface.

The CPU 130 controls each unit forming the wireless communication system, and performs predetermined processing and the like. The memory 140 and the HDD 150 function as a storage unit that stores various data and the like. The storage medium 170 stores a program for executing each function of the wireless communication system. Note that the architecture forming the wireless communication system is not limited to the example illustrated in FIG. 3.

The “computer” as used herein includes an OS and hardware such as peripheral devices. The “computer-readable storage medium” is, for example, a portable medium such as a flexible disk, a magneto-optical disk, a ROM, or a CD-ROM.

Furthermore, the “computer-readable storage medium” may be a medium that dynamically holds a program for a short period of time like a communication line in a case where the program is transmitted via a network such as the Internet or a communication line such as a telephone line. In addition, the “computer-readable storage medium” may be a medium that holds a program for a certain period of time, such as a volatile memory inside a computer serving as a server or a client.

### INDUSTRIAL APPLICABILITY

A wireless communication system, a method of controlling a wireless communication system, and a wireless master station device according to the present invention can be applied to, for example, a mobile base station that provides wireless communication.

### REFERENCE SIGNS LIST

10 Wireless master station device
11 Control unit
12 Wireless unit
13 Interface unit
20 Wireless slave station device
21 Control unit
22 Wireless unit
23 Interface unit
100 Input unit
110 Output unit
120 Communication unit
130 CPU
140 Memory
150 HDD
160 Bus
170 Storage medium

1. A wireless communication system for accommodating a plurality of different services, the wireless communication system comprising:
a wireless master station; and
a wireless slave station,
wherein:
the wireless master station and the wireless slave station perform wireless communication using an adaptive modulation technique via a plurality of ports,
a priority is set to each of the plurality of ports in accordance with a type of service accommodated by the port, and
when a radio band decreases due to deterioration of a wireless environment, the ports are blocked in order of low priority, and when the radio band recovers due to improvement of the wireless environment, the blocked ports are opened in order of high priority.

2. A method of controlling a wireless communication system including a wireless master station and a wireless slave station that perform wireless communication using an adaptive modulation technique via a plurality of ports and accommodating a plurality of services, the method comprising:
setting a priority to each of the plurality of ports according to a type of service accommodated by the port:
blocking the ports in order of low priority when a radio band decreases due to deterioration of a wireless environment; and
opening the blocked ports in order of high priority when the radio band recovers due to improvement of the wireless environment.

3. A wireless master station device that accommodates a plurality of different services by performing wireless communication using an adaptive modulation technique with a wireless slave station via a plurality of ports, the wireless master station comprising:
wireless circuitry that performs wireless communication with the wireless slave station;
control circuitry that controls a modulation scheme of communication by the wireless unit according to a change in a wireless environment; and
an interface that blocks and opens the plurality of ports,
wherein:
a priority is set to each of the plurality of ports in accordance with a type of service accommodated by the port, and
the control circuitry controls the interface so as to block the ports in order of low priority when a radio band decreases due to deterioration of the wireless environment, and to open the blocked ports in order of high priority when the radio band recovers due to improvement of the wireless environment.
